(19) United States
(12) Patent Application Publication
(10) Pub. No.: US 2011/0116807 A1
(43) Pub. Date: May 19, 2011

(54) EXPRESS INTERFACE APPARATUS USING OPTICAL CONNECTION

(75) Inventors: Hyo Hoon PARK, Daejeon (KR); Tae Woo LEE, Daejeon (KR); Min Hyuk LEE, Daejeon (KR); Mu Hee CHO, Daejeon (KR); Seong Woon KIM, Chungcheongnam-Do (KR)

(73) Assignee: KAIST (Korea Advanced Institute of Science and Technology), Daejeon (KR)

(21) Appl. No.: 12/696,668

(22) Filed: Jan. 29, 2010

(30) Foreign Application Priority Data
Nov. 16, 2009 (KR) 10-2009-0110105

(51) Int. Cl. H04B 10/00

(52) U.S. Cl. 398/164

(57) ABSTRACT

An express interface apparatus using an optical connection is provided. The apparatus connects between a central processing unit (CPU) in a computer system and an external device supporting optical signal transfer using a peripheral component interconnect express (PCIE) supporting high-speed signal processing. The apparatus includes an optical connection module for connecting the external device so that an optical signal is input/output; an optical-to-electrical conversion module for converting the optical signal from the optical connection module into an electrical signal or converting an electrical signal into an optical signal; a signal processing module connected to the optical-to-electrical conversion module for performing signal processing to divide or merge the electrical signal; and a PCIE control module for controlling a processed signal from the signal processing module to deliver the signal to the CPU via a PCIE slot and controlling high-speed data transmitted and received between the CPU and the external device, such that a signal can be transmitted and received without a distortion or bottleneck phenomenon in high-speed data transfer.

### CROSS-REFERENCE TO RELATED APPLICATION

This application claims priority to and the benefit of Korean Patent Application No. 2009-0110105, filed on Nov. 16, 2009, the disclosure of which is incorporated herein by reference in its entirety.

### BACKGROUND

1. Field of the Invention

The present invention relates to an express interface apparatus, and more particularly, to an express interface apparatus using an optical connection for enabling signal transmission and reception to be performed without a distortion or bottleneck phenomenon in high-speed data transfer by performing optical-to-electrical conversion and signal processing for high-speed data transmission and reception between a peripheral component interconnect express (PCIE) supporting high-speed signal processing and an external device supporting optical signal transfer.

2. Discussion of Related Art

In general, a universal serial bus (hereinafter, referred to as “USB”) is a protocol for a next-generation interface substituting for conventional general serial ports. The USB may be said to be an external bus for connecting a computer system with peripheral devices, such as a keyboard, a mouse, a monitor, a modem, a printer, etc.

A USB connector is used to transmit and receive data according to a USB standard and typically includes an A-type plug connected to a computer system with a minitype plug connected to a peripheral device, in which the plugs are connected to each other using a cable. The USB connector is used for data sharing between the computer system and portable electronic devices, such as a portable phone, a portable computer, a palm PC, a personal digital assistant (PDA), an electronic organizer, and the like, as well as for the connection between the computer and the peripheral devices.

Recently, MP3 players, recharge cards, digital camera phones or portable memory storages have been widely used. A Bluetooth USB connector for a connection between such portable electronic devices and a computer system uses a general printed circuit board (PCB) or a flexible PCB, rather than cables, to connect between an A-type plug and a mini type plug.

A user downloads and uses songs or data by directly inserting the USB connector of the devices into a USB port of a personal computer (PC) or other computer. The USB connector allows for a direct connection without a separate cable, thereby providing convenience of use.

However, since a storage capacity and an internet speed have entered a G (giga) generation and data connections between a PC and peripheral devices require a higher transfer speed, USB 2.0 does not satisfy an increasing demand for an access speed. Accordingly, it is necessary to use a new interface standard for the data connections between the PC and the peripheral devices.

One solution is to draw a SATA interface from a computer case using an e serial advanced technology attachment (eSATA) interface. This SATA interface can support a 3 Gb/S bandwidth. However, since the SATA interface does not provide a power signal, it cannot supply power to a device. Also, since the SATA interface supports only simple storage, it cannot be used to connect a number of consumer electronic devices to the computer. Further, this solution is incompatible with many conventional USB devices.

Meanwhile, a general computer system employs a peripheral component interconnect (PCI) bus as a representative input/output bus. Recently, the PCI bus has been replaced with a new PCI Express (hereinafter, referred to as “PCIE”).

PCIE is a serial bus supporting a point to point connection. A minimal PCIE architecture as an interface that simplifies a receiving side and a transmitting side is defined as x1, and PCIE architectures x2, x4, x8, x16, and x32 are used depending on applications. The PCIE architectures are used to provide a scalable bandwidth.

Currently, x1 is used for a universal input/output (I/O) slot for a desktop computer and x16 is used for graphics. In addition, PCIE is characterized by a point to point connection, a scalable bandwidth, and low voltage differential signaling. PCIE may be applicable to a server in the future, as well as a desktop PC and a laptop computer.

Applications for a PC platform with a chipset supporting a PCIE interface include Gigabit Ethernet, storage, wireless communication, and the like. An interface between the applications and the chipset includes a data path (DP) and a clock path (CP). However, a conventional PCIE interface apparatus has no compatibility with external devices supporting an optical signal.

### SUMMARY OF THE INVENTION

The present invention is directed to an express interface apparatus using an optical connection that enables signal transmission and reception to be performed without a distortion or bottleneck phenomenon in high-speed data transfer by performing optical-to-electrical conversion and signal processing for high-speed data transmission and reception between a peripheral component interconnect express (PCIE) supporting high-speed signal processing and an external device supporting optical signal transfer.

According to an aspect of the present invention, there is provided an express interface apparatus using an optical connection for connecting between a central processing unit (CPU) in a computer system and an external device supporting optical signal transfer using a peripheral component interconnect express (PCIE) supporting high-speed signal processing, the apparatus including: an optical connection module for connecting the external device so that an optical signal is input/output; an optical-to-electrical conversion module for converting the optical signal from the optical connection module into an electrical signal or converting an electrical signal into an optical signal; a signal processing module connected to the optical-to-electrical conversion module for performing signal processing to divide or merge the electrical signal; and a PCIE control module for controlling a processed signal from the signal processing module to deliver the signal to the CPU via a PCIE slot and controlling high-speed data transmitted and received between the CPU and the external device.

Here, the optical connection module and the optical-to-electrical conversion module may be connected to each other via an optical transfer unit for optical signal transfer.

The optical transfer unit may include at least one of an optical fiber, an optical waveguide, and an optical printed circuit board (PCB).

The optical-to-electrical conversion module and the signal processing module may be connected to each other via an electrical link capable of transferring a high-speed signal.

The optical connection module may include first and second optical connection members, the first optical connection member may include an optical transfer path including at least one optical fiber or optical waveguide, and a first connector with a guide hole, and the second optical connection member may include an optical transfer path including at least one optical fiber or optical waveguide, and a second connector with a guide pin inserted into the guide hole.

The guide hole and the guide pin may be connected to a power terminal of the PCIE slot via power lines so that power is supplied to the external device.

The apparatus may further include: an electrical slot unit for connection with an external device supporting electrical signal transfer; and a switching unit connected between the optical-to-electrical conversion module and the signal processing module, for performing switching to selectively connect the signal processing module to the electrical slot unit or the optical-to-electrical conversion module according to a signal from external devices connected to the optical connection module and the electrical slot unit.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a block diagram of a computer system with an express interface apparatus according to an exemplary embodiment of the present invention;

FIG. 2 is a block diagram of an express interface apparatus using an optical connection according to an exemplary embodiment to the present invention;

FIG. 3 is a plan view illustrating an optical connection module applied to the exemplary embodiment of the present invention; and

FIG. 4 is a block diagram of an express interface apparatus using an optical connection according to another exemplary embodiment of the present invention.

### DETAILED DESCRIPTION OF EXEMPLARY EMBODIMENTS

Exemplary embodiments of the present invention will be described in detail below with reference to the accompanying drawings. While the present invention is shown and described in connection with exemplary embodiments thereof, it will be apparent to those skilled in the art that various modifications can be made without departing from the spirit and scope of the invention.

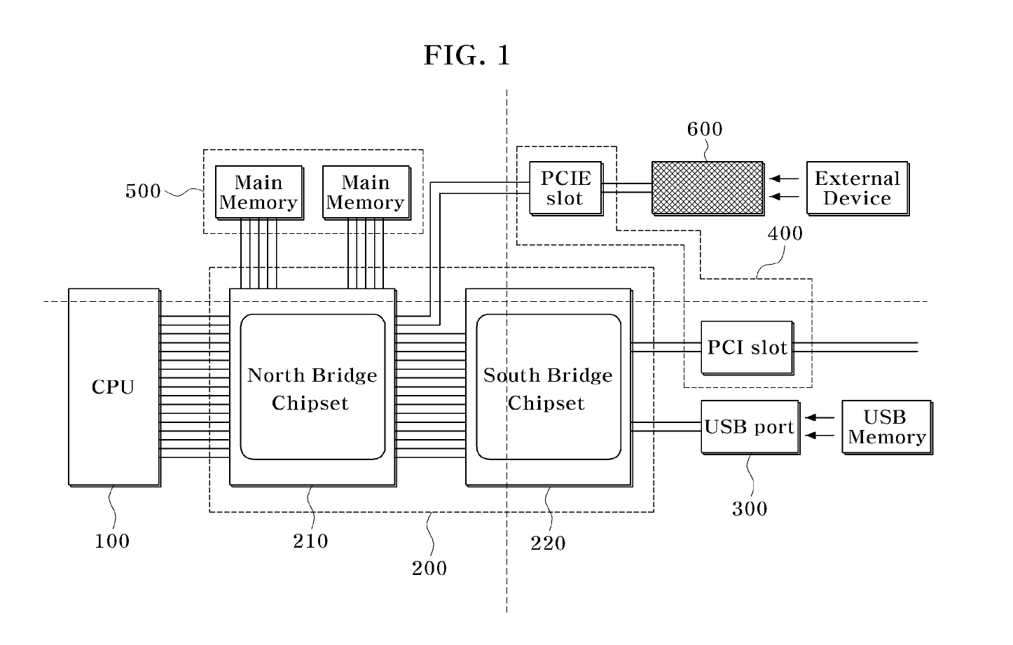

FIG. 1 is a block diagram of a computer system with an express interface apparatus according to an exemplary embodiment of the present invention.

Referring to FIG. 1, a computer system with an express interface apparatus according to an exemplary embodiment of the present invention may include a central processing unit (CPU) 100 as a processor, a main-board chipset 200, various input/output (I/O) ports (e.g., USB ports) 300, an extension slot 400 such as a peripheral component interconnect (PCI)/peripheral component interconnect express (PCIE) slot, a main memory 500 such as a ROM or a flash memory with a basic input output system (BIOS), an express interface apparatus 600 for connecting an external device supporting optical signal transfer via the PCIE slot, and peripheral devices, such as a graphic card (not shown), a sound card (not shown), and a LAN card (not shown).

Here, the main-board chipset 200 controlling an overall computer system may include a North Bridge chipset 210 and a South Bridge chipset 220.

The North Bridge chipset 210 controls high-speed devices such as the CPU 100, the main memory 500, the PCIE extension slot, and the graphic card (not shown), and the South Bridge chipset 220 controls input/output among components (e.g., a HDD, an audio controller, a BIOS ROM, an Ethernet/wireless LAN/minicard, a turbo memory, a USB, and an embedded controller) mounted on the main-board.

For example, the North Bridge chipset 210 and the South Bridge chipset 220 may be available from Intel, AMD, nVIDIA, VIS, and SIS.

In particular, the express interface apparatus 600 according to the present invention connects between the CPU 100 in the computer system and an external device supporting optical signal transfer using PCIE supporting high-speed signal processing. The express interface apparatus 600 includes a slot connected to the main-board of the computer, a control module for suitably controlling a signal in the slot, a signal processing module for converting a controlled signal from the control module into a signal suitable for optical signal transfer, an optical-to-electrical conversion module for converting an electrical signal from the signal processing module into an optical signal, and an optical transfer unit for transferring the optical signal.

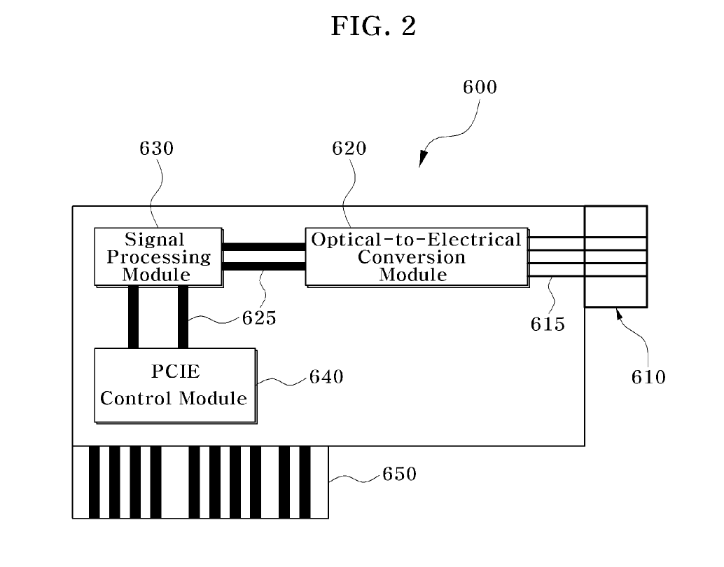

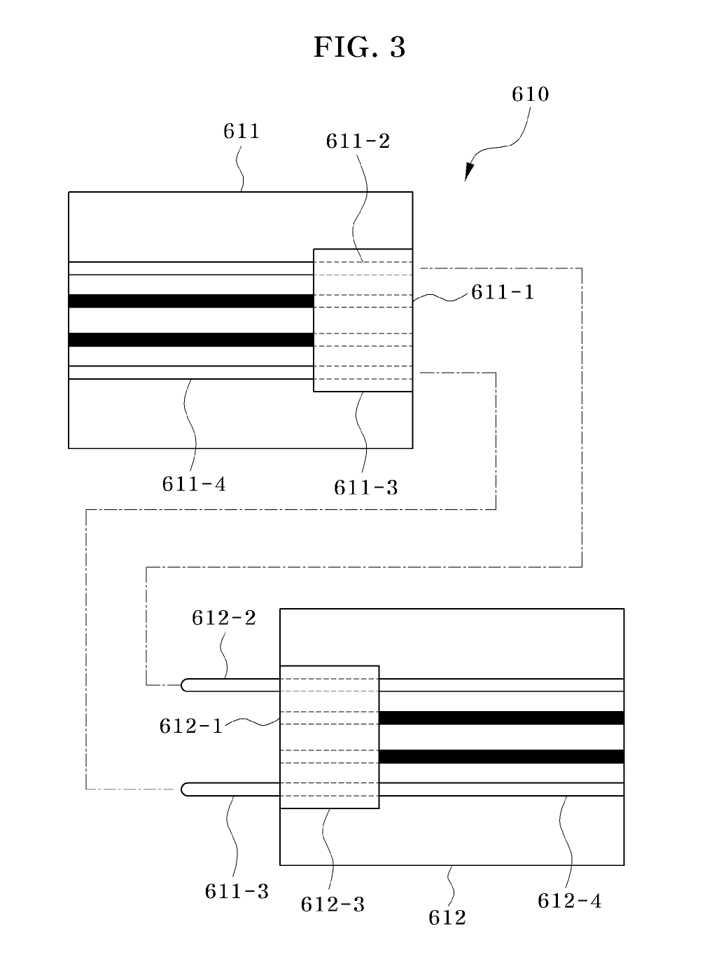

FIG. 2 is a block diagram of an express interface apparatus using an optical connection according to an exemplary embodiment to the present invention, and FIG. 3 is a plan view illustrating an optical connection module applied to the exemplary embodiment of the present invention.

Referring to FIGS. 2 and 3, an express interface apparatus 600 using an optical connection according to an exemplary embodiment of the present invention includes an optical connection module 610, an optical-to-electrical conversion module 620, a signal processing module 630, a PCIE control module 640, and a PCIE slot 650.

The optical connection module 610 is called an optical serial bus (OSB) and is a signal transfer unit for transferring an optical signal. Generally, the optical connection module 610 may include an optical printed circuit board (PCB) for transferring an optical signal, a physical device of a port for connecting the express interface apparatus of the present invention to the exterior, and units for transferring the optical signal via the physical device. However, in the present invention, the optical connection module 610 may be male/female ports, i.e., first and second optical connection members 611 and 612, capable of transferring an optical signal to the exterior.

As shown in FIG. 3, the optical connection module 610 is used to connect an external device so that an optical signal is input/output and includes the first and second optical connection members 611 and 612.

The optical connection member 611 includes an optical transfer path 611-1 including, for example, at least one optical fiber or optical waveguide, and a MT ferrule or a first connector 611-3 with at least one guide hole 611-2.

The second optical connection member 612 includes an optical transfer path 612-1 including, for example, at least one optical fiber or optical waveguide, and a MT ferrule or a second connector 612-3 with a guide pin 612-2 inserted into the guide hole 611-2.

That is, in the second connection member 612, the guide pin 612-2 and the optical transfer path 612-1 are maintained at a constant distance and fixed. The second connection member 612 is connected with the external device for supporting the express interface apparatus of the present invention. The guide pin 612-2 is connected to the guide hole 611-2 to support the express interface apparatus of the present invention, and the optical transmission paths 611-1 and 612-1 transmit and receive the optical signal to and from an external device.

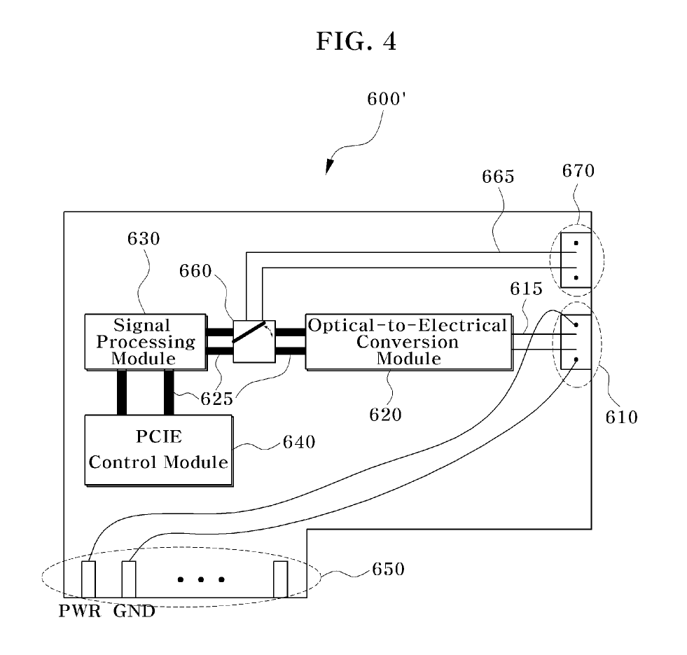

Meanwhile, the guide hole 611-2 and the guide pin 612-2 are connected to a power terminal PWR and a ground GND of the PCIE slot 650 via power lines 611-4 and 612-4, so that power can be supplied to the external device (see FIG. 4).

The optical-to-electrical conversion module 620 is connected to the optical connection module 610 via an optical transfer module 615, for converting the optical signal from the optical connection module 610 into an electrical signal or an electrical signal into an optical signal.

The optical-to-electrical conversion module 620 may include a photo detector for converting an optical signal into an electrical signal, a laser diode, and a driver IC and a receiver IC for causing the electrical signal to be transmitted and received as an electrical signal having a proper level.

That is, the optical-to-electrical conversion module 620 converts the optical signal received via the optical transfer module 615 into an electrical signal or converts an electrical signal from the signal processing module 630 into an optical signal. The received optical signal is converted into an electrical signal by the photo detector, subjected to suitable signal processing in the receiver IC, and transmitted to the signal processing module 630. When an electrical signal is received from the signal processing module 630, the electrical signal is converted into an optical signal by the driver IC and the laser diode and transmitted to the optical connection module 610.

The optical transfer module 615 is an optical link for connecting the optical signal from the optical connection module 610 to the optical-to-electrical conversion module 620. The optical transfer module 615 is limited to the optical transfer path in the present invention. The optical transfer path may be an optical fiber stacked on a PCB. Alternatively, the optical transfer path may be an optical waveguide such as a waveguide or a polymer in a stacked form or a non-stacked form.

That is, the optical transfer module 615 is an optical PCB with a stacked optical fiber or an optical waveguide having the same function, as described above. The optical transfer module 615 transfers the optical signal from the optical connection module 610 to the optical-to-electrical conversion module 620.

The signal processing module 630 is connected to the optical-to-electrical conversion module 620 via an electrical link (e.g., a power line) 625, for example, for performing signal processing to divide a serial electrical signal into parallel electrical signals or merge parallel electrical signals into a serial electrical signal.

The signal processing module 630 may include a serializer and deserializer (SerDes) or an equivalent muxing/deMuxing device, and a device for suitably assisting the SerDes in operating according to a clock.

That is, the signal processing module 630 divides a high-speed signal into signals according to a processing speed of the PCIE control module 640 or merges signals from the PCIE control module 640 to be a high-speed signal.

In this case, the electrical signal merger or division is performed by the SerDes. In order for the SerDes to suitably perform the electrical signal merger or division, for example, circuits such as PLL and a clock circuit are connected to the SerDes to correct signals.

The PCIE control module 640 is connected with the signal processing module 630 via an electrical link 625. The PCIE control module 640 controls a processed signal from the signal processing module 630 to deliver the resultant signal to the CPU via the PCIE slot 650 and controls high-speed data transmitted and received between the CPU and the external device.

That is, the PCIE control module 640 is connected to the North Bridge chipset 210 of the main-board (see FIG. 1) of the computer system via the PCIE slot 650, and performs control for correct operation according to a signal system in signal transmission and reception.

Meanwhile, the PCIE slot 650 may include an electrical-signal transfer path according to the PCIE standard, and the PCB in the present invention may be formed of a material suitable for high-speed signal transfer, such as multilayer FR4 or ceramic.

FIG. 4 is a block diagram of an express interface apparatus using an optical connection according to another exemplary embodiment of the present invention, in which both an external device supporting optical signal transfer and an external device supporting electrical signal transfer are used.

Referring to FIG. 4, an express interface apparatus 600′ using an optical connection according to another exemplary embodiment of the present invention includes an optical connection module 610, an optical-to-electrical conversion module 620, a signal processing module 630, a PCIE control module 640, a PCIE slot 650, a switching unit 660, and an electrical slot unit 670.

Here, since the optical connection module 610, the optical-to-electrical conversion module 620, the signal processing module 630, the PCIE control module 640 and the PCIE slot 650 are the same as those in the above-described exemplary embodiment of the present invention, a detailed description of such components will be omitted.

The switching unit 660 is connected between the optical-to-electrical conversion module 620 and the signal processing module 630 via an electrical link 625, and has a switching function to selectively connect the signal processing module 630 to the electrical slot unit 670 or the optical-to-electrical conversion module 620 according to an input/output signal of an external device connected to the optical connection module 610 and an external device connected to the electrical slot unit 670.

The electrical slot unit 670 is connected to the switching unit 660 via an electrical link 665, and serves as a transfer path for connecting to the external device supporting electrical signal transfer (e.g., a USB device).

The express interface apparatus configured as above according to another exemplary embodiment of the present invention includes the switching unit 660 provided between the optical-to-electrical conversion module 620 and the signal processing module 630, for selecting one of the connections with the two external input/output terminals according to a port and a signal system supported by the external devices.

If the switching unit 660 is connected to the electrical link 665, a signal from the external device supporting electrical signal transfer (e.g., a USB device) is communicated to the signal processing module 630, subjected to a signal system conversion process suitable for the signal system, and delivered to the PCIE slot 650. If the switching unit 660 is connected via the optical transfer module 615 that is an optical link, the same operation as in the above-described exemplary embodiment of the present invention is performed.

Meanwhile, the express interface apparatus according to exemplary embodiments of the present invention may be connected to the PCIE slot 650 because relatively high-speed data transfer can be performed as the PCIE slot is directly connected to the North Bridge chipset 210.

That is, according to the present invention, PCIE can be connected with USB 3.0 using the characteristic of PCIE capable of performing high-speed data transfer, and an external device supporting high-speed optical signal transfer can be connected to the North Bridge chipset 210 of the computer system using the PCIE slot 650.

According to the present invention, a next-generation movable device supporting high-speed data transfer, such as a USB 3.0 device, and a device supporting high-speed optical signal transfer can be suitably connected to a computer system.

According to the present invention, the apparatus capable of connecting between PCIE providing the highest-speed external device connection and an external device can be provided, such that degradation of an original data transfer speed of the external device can be prevented. With the development of technology, PCIE may be replaced with other slots.

According to the present invention, a distortion phenomenon due to impedance mismatching and data instability easily occurring in high-speed transfer can be resolved by applying the optical connection, which can contribute to the development of a next-generation high-speed computer.

As described above, with the express interface apparatus using an optical connection of the present invention, optical-to-electrical conversion and signal processing are performed for high-speed data transmission and reception between PCIE supporting high-speed signal processing and an external device supporting optical signal transfer, thereby achieving signal transmission and reception without a distortion or bottleneck phenomenon in high-speed data transfer.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. An express interface apparatus using an optical connection for connecting between a central processing unit (CPU) in a computer system and an external device supporting optical signal transfer using a peripheral component interconnect express (PCIE) supporting high-speed signal processing, the apparatus comprising:
an optical connection module for connecting the external device so that an optical signal is input/output;
an optical-to-electrical conversion module for converting the optical signal from the optical connection module into an electrical signal or converting an electrical signal into an optical signal;
a signal processing module connected to the optical-to-electrical conversion module for performing signal processing to divide or merge the electrical signal; and
a PCIE control module for controlling a processed signal from the signal processing module to deliver the signal to the CPU via a PCIE slot and controlling high-speed data transmitted and received between the CPU and the external device.

2. The apparatus of claim 1, wherein the optical connection module and the optical-to-electrical conversion module are connected to each other via an optical transfer unit for optical signal transfer.

3. The apparatus of claim 2, wherein the optical transfer unit comprises at least one of an optical fiber, an optical waveguide, and an optical printed circuit board (PCB).

4. The apparatus of claim 1, wherein the optical-to-electrical conversion module and the signal processing module are connected to each other via an electrical link capable of transferring a high-speed signal.

5. The apparatus of claim 1, wherein the optical connection module comprises first and second optical connection members,
the first optical connection member comprises an optical transfer path including at least one optical fiber or optical waveguide, and a first connector with a guide hole, and
the second optical connection member comprises an optical transfer path including at least one optical fiber or optical waveguide, and a second connector with a guide pin inserted into the guide hole.

6. The apparatus of claim 5, wherein the guide hole and the guide pin are connected to a power terminal of the PCIE slot via power lines so that power is supplied to the external device.

7. The apparatus of claim 1, further comprising:
an electrical slot unit for connection with an external device supporting electrical signal transfer; and
a switching unit connected between the optical-to-electrical conversion module and the signal processing module, for performing switching to selectively connect the signal processing module to the electrical slot unit or the optical-to-electrical conversion module according to a signal from external devices connected to the optical connection module and the electrical slot unit.
